(19) United States
(12) Patent Application Publication
(10) Pub. No.: US 2026/0010601 A1
(43) Pub. Date: Jan. 8, 2026

(54) BIOMETRIC ENCODING METHOD AND TERMINAL

(71) Applicant: IDEMIA PUBLIC SECURITY FRANCE, Courbevoie (FR)

(72) Inventors: Hervé CHABANNE, Courbevoie (FR); Vincent DESPIEGEL, Courbevoie (FR)

(73) Assignee: IDEMIA PUBLIC SECURITY FRANCE, Courbevoie (FR)

(21) Appl. No.: 19/222,490

(22) Filed: May 29, 2025

(30) Foreign Application Priority Data
Jul. 3, 2024 (FR) FR2407238

(51) Int. Cl. G06F 21/32

(52) U.S. Cl. CPC G06F 21/32

(57) ABSTRACT

A method for encoding, implemented by an encoding terminal, a proof biometric template, said method having, as input datum, a proof biometric feature, and delivering, as output datum, a proof biometric template, wherein the proof biometric template is generated from the proof biometric feature according to an encoding scheme representative of the distance, according to a metric, between the proof biometric feature and a reference biometric feature.

### TECHNICAL FIELD

The present invention relates to a biometric encoding method and terminal. It also relates to an identification method and system implementing the biometric encoding method and terminal.

### TECHNICAL BACKGROUND

It is common to use protocols to identify and/or authenticate individuals based on comparison of certain of their biometric features in order to allow them to access remote services, permit access to information stored in a communal or personal database, verify an identity or even permit access to a restricted area.

Irrespectively of whether it is a question of authentication or identification, the comparison of biometric features is generally not implemented on directly recorded raw data but rather biometric data derived by applying algorithmic processing referred to as encoding. According to Section 3.21 of the standard ISO/IEC 19794-1:2011 Information technology—Biometric data interchange formats—Part 1: Framework, the derived biometric data form a “biometric template” or “biometric model” that differs from the raw data used to obtain it, and that may be compared to other biometric templates.

Biometric authentication generally consists in comparing a proof biometric template acquired for an individual to a single or very limited number of reference biometric templates (1:1). This type of protocol allows a user who wishes to access resources of an information system, such as an operating system, a network, an application, a service, a database or an app, to prove her or his identity using a biometric feature. An authentication protocol generally requires a prior step of enrolment in which a user identifies her or himself by sharing a certain amount of information regarding her or his identity with the entity implementing the protocol.

Carrying out a banking operation remotely, accessing a password database stored on a smartphone, or verifying, during a border crossing or during a stop by law enforcers, the identity of an individual bearing an identity document comprising a secure electronic element on which biometric information is stored are common examples of application of an authentication protocol.

WO 9526013 A1 [MINNESOTA MINING & MFG [US]]28.09.1995 describes a system that achieves authentication by comparing a proof biometric feature acquired from an individual with a reference biometric feature stored in the system. The system is further configured to detect a variable biometric feature to verify the liveness of the individual.

Unlike authentication, identification requires comparison of a proof biometric template with many other reference biometric templates that are acquired beforehand from several individuals (1:N search) and generally stored in a database. This type of protocol makes it possible to identify one user among a set of users. The database of reference biometric templates generally requires a prior step of enrolment of biometric templates collected from identified individuals.

Determining, for example in the context of a police investigation, the identity of a person by comparing a dactylogram of her or his dermatoglyphics, an image of her or his iris or an image of her or his face with those of a database of known individuals is a common application of an identification protocol. Another example of application is limiting access to a restricted area to a limited number of individuals.

U.S. Pat. No. 4,109,237 A [HILL ROBERT B]22.08.1978 describes a method of identification of an individual by comparing her or his retinal vasculature intercept pattern with a set of previously stored retinal vasculature intercept pattern of a plurality of individuals.

It is now common for users, when they wish to interact with a remote resource, to authenticate and/or identify themselves using a mobile device, such as a smartphone, tablet or laptop computer, in communication with the resource. However, biometric data, whether in raw or template form, are highly sensitive personal data. It is necessary to ensure their confidentiality, and thereby prevent them from being stolen and/or used for the purpose of identity theft.

EP 2 813 961 A1 [KONVALINKA IRA [CA]]17.12.2014 describes a biometric authentication method employing a mobile device coupled to a remote server. The device comprises a biometric sensor and a memory on which a personal reference biometric template specific to its user is stored. At the request of the server, the user acquires a proof biometric feature using the biometric sensor of the mobile device. Next, the device generates a proof biometric template, compares it with the personal reference biometric template, and transmits a pass or fail signal to the remote server. During this operation, biometric information is confined to the mobile device and is never communicated to the server. The confidentiality thereof is preserved. In contrast, the remote server has no guarantee as to the real identity of the user of the mobile device.

It is possible to enhance the security of authentication or identification protocols, and in particular decrease the risk of identity theft, by using a biometric authentication or identification terminal coupled to a mobile device. The terminal is configured to acquire biometric features of an individual and to generate an additional proof biometric template therefrom. The additional proof biometric template may then be compared with a reference biometric template.

WO 2017/019972 A1 [VISA INT SERVICE ASS [US]]02.02.2017 describes a biometric authentication method employing a mobile device coupled to an access terminal equipped with a biometric sensor. A personal reference biometric template specific to its user is stored on the mobile device. The mobile device is configured to receive a proof biometric template generated by the access terminal, to compare said proof biometric template with the personal reference biometric template, and to send the result of the comparison to the access terminal.

WO 2017/075063 A1 [VISA INT SERVICE ASS [US]]04.07.2017 describes a method allowing individuals nearby a biometric access terminal to be authenticated using their mobile devices without the individuals having to acquire a biometric feature using their mobile device. The access terminal is configured to receive, from each nearby mobile device, a public encryption key generated by applying a first fuzzy extractor to a personal reference biometric template that is stored on each mobile device and specific to its user. Next, the access terminal generates a proof biometric template from biometric features acquired from a user, and generates secret encryption keys by applying a second fuzzy extractor to the proof biometric template and each of the received public encryption keys; there are as many secret encryption keys as there are received public encryption keys. Next, it encrypts the proof biometric template with each of the secret keys to generate as many encrypted biometric templates as there are secret encryption keys. These encrypted biometric templates are then sent to all the nearby mobile devices. If a mobile device successfully decrypts one of the encrypted proof biometric templates, it compares it to the personal reference biometric template that is specific thereto, and if a match is found, sends a success signal to the access terminal, which permits the mobile device to access a resource.

WO 2019/078858 A1 [VISA INT SERVICE ASS [US]]25.04.2019 describes a biometric authentication method limiting the risk of man-in-the-middle attacks. A first proof biometric template of an individual is generated by a mobile device such as a smartphone or laptop computer from biometric features acquired via a first acquisition. The first biometric template is stored locally on the mobile device and an encrypted copy is sent to an authentication terminal allowing access to a resource such as a database, a computer network, or an area to which access is restricted. The terminal generates a proof second biometric template of the individual from biometric features acquired via a second acquisition, computes an encrypted result based on the encrypted first biometric template and on the second biometric template by applying an encryption function, and then sends the encrypted result to the mobile device. The mobile device decrypts the encrypted result, compares the decrypted first biometric template with the locally stored first biometric template, and if there is a match, compares the first biometric template with the second biometric template. If the first biometric template and the second biometric template match, the mobile device sends identification information such as a user name, password or identity number.

WO 2019/094071 A1 [VISA INT SERVICE ASS [US]]16.05.2019 describes a method of biometric identification of individuals nearby a biometric access terminal allowing the number of comparisons of a proof biometric template with the reference biometric templates of a database to be decreased. The terminal has access to a database of reference biometric templates of users previously enrolled with their mobile devices. The reference biometric templates are obfuscated in the database. When the access terminal detects the mobile device of an enrolled user nearby, it acquires proof biometric features of the owner of the mobile device, generates a proof biometric template, and compares it with the reference biometric template associated with the mobile device stored in the database.

### SUMMARY OF THE INVENTION

A major drawback of current authentication or identification methods is the possibility of false acceptance should an interloper purloin a user's mobile device and submit a proof biometric feature close to the reference biometric feature with a view to accessing the services provided via the identification or authentication terminal.

There is therefore a need for a solution allowing the risk of false acceptance during an identification and authentication process employing an intermediate mobile device to be decreased. Furthermore, such a solution would ideally increase the confidentiality and security of the biometric information.

According to a first aspect of the invention, a method for encoding, implemented by an encoding terminal, a proof biometric template is provided, said method having, as input datum, a proof biometric feature, and delivering, as output datum, a proof biometric template, wherein the proof biometric template is generated from the proof biometric feature according to an encoding scheme representative of the distance, according to a metric, between the proof biometric feature and a reference biometric feature.

According to certain embodiments, the encoding scheme comprises a pre-encoder configured to generate an internal reference biometric template generated from the reference biometric feature and an intermediate proof biometric template generated from the proof biometric feature, the distance according to a metric being a distance between the internal reference biometric template and the intermediate proof biometric template.

According to certain embodiments, the encoding scheme comprises a transition function or a distribution function centered on the distance according to a metric between an internal reference biometric template generated from the reference biometric feature and an intermediate proof biometric template generated from the proof biometric feature.

According to certain embodiments, the encoding scheme further comprises a noise-generation function, preferably a noise-generation function that has, as input variable, the proof biometric feature.

According to certain embodiments, the noise-generation function comprises a function that generates a random number from the proof biometric feature, selected from a hash function, a weighted summation function and a reduction function.

According to certain embodiments, the encoding scheme is implemented in the form of a neural network trained beforehand using a teacher-student protocol.

According to certain embodiments, the encoding scheme is specific to the biometric terminal.

According to certain embodiments, the reference biometric feature is specific to the user of the encoding terminal.

According to a second aspect of the invention, an encoding terminal for implementing an encoding method according to any embodiment of the first aspect of the invention is provided.

According to certain embodiments, the encoding terminal is a mobile electronic device, preferably a smartphone.

According to a third aspect of the invention, a biometric identification method is provided that comprises the following steps:
a) transmission, by a biometric identification terminal, of a proof biometric feature of an individual to an encoding terminal;
b) generation, by the encoding terminal, of a proof biometric template using an encoding method according to any embodiment of the first aspect of the invention;
c) reception, by the biometric identification terminal, of the proof biometric template;
d) comparison, by the biometric identification terminal, of the proof biometric template with at least one reference biometric template of a database of reference biometric templates.

According to certain embodiments, comparison step d) is executed using a fuzzy search protocol, preferably a fuzzy search protocol based on a Hamming distance.

According to certain embodiments, the biometric identification method further comprises a step of generation, by the encoding terminal, of a proof of encoding of the proof biometric template from the proof biometric feature, preferably a zero-knowledge encoding proof, and a step of verification, by the biometric identification terminal, of the encoding proof.

According to certain embodiments, comparison step (d) is executed using a data-obfuscation and/or function-obfuscation method.

According to a fourth aspect of the invention, a biometric identification system for implementing an identification method according to any embodiment of the third aspect of the invention is provided. In particular, a biometric identification system is provided that comprises:
a biometric identification terminal comprising an acquisition device configured to acquire at least one biometric feature of a user;
a storage medium comprising a database of reference biometric templates;
an encoding terminal according to any embodiment of the second aspect of the invention;
the system being configured to execute the steps of a biometric identification method according to any embodiment of the third aspect of the invention.

### BRIEF DESCRIPTION OF THE DRAWINGS

FIG. 1 is a schematic representation of a biometric identification system comprising a biometric identification terminal and an encoding terminal.

FIG. 2 is a schematic representation of a biometric identification terminal.

FIG. 3 is a schematic representation of an encoding terminal.

FIG. 4 is a chart of operation of a biometric identification terminal according to a first embodiment.

FIG. 5 is a chart of operation of an encoding terminal according to a first embodiment.

FIG. 6 is a chart of operation of an encoding terminal according to a second embodiment.

FIG. 7 is a chart of operation of a biometric identification terminal according to a first embodiment.

FIG. 8 is a flowchart of an encoding method according to the invention.

FIG. 9 is a flowchart of an encoding method according to a first embodiment.

FIG. 10 is a flowchart of an encoding method according to a second embodiment.

FIG. 11 is a flowchart of an encoding method according to a third embodiment.

### DETAILED DESCRIPTION OF EMBODIMENTS

In the present disclosure, embodiments are described in the general context of one or more pieces of hardware or devices capable of executing preloaded instructions such as, for example, computer-executable instructions for executing program modules. The program modules may include one or more routines, programs, objects, variables, commands, scripts, functions, applications, components and/or data structures able to execute particular tasks or implement particular types of abstract data.

Certain embodiments may also be implemented in distributed computing environments where tasks are executed by remote data-processing devices that are connected by a communication network. In a distributed computing environment, the program modules may reside on local and/or remote computer storage media, including memory storage devices.

In the context of the invention, what is meant by “biometric template” is any type of biometric data derived from one or more raw biometric features following processing thereof by an algorithm, this processing being referred to as encoding below. The derived biometric data forming the biometric template generally differ from the raw biometric data from which they are derived. Preferably, the biometric template conforms to the definition of the standard ISO/IEC 19794-1:2011 Information technology—Biometric data interchange formats—Part 1: Framework.

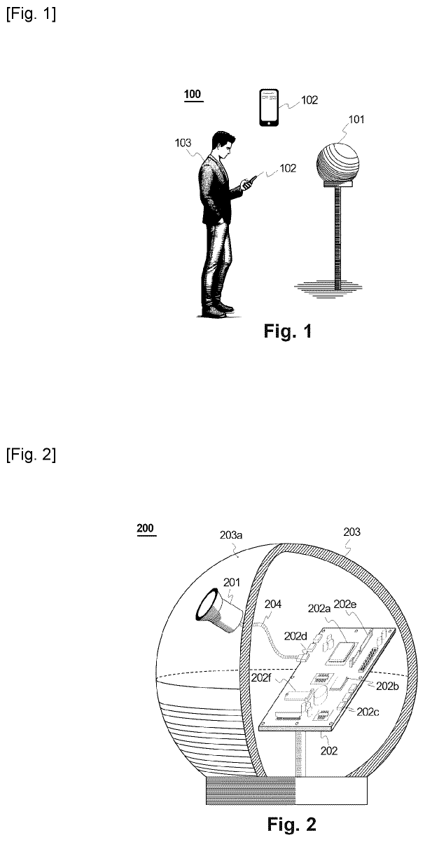

With reference to FIG. 1, a biometric identification system 100 may comprise a biometric identification terminal 101 and an encoding terminal 102 associated with or specific to a user 103. The biometric identification terminal 101 and the encoding terminal 102 are preferably configured to exchange data via a secure remote connection.

When a user 101 wishes to identify her or himself to the biometric identification terminal 101 in order to access a resource or an area to which access is restricted, she or he first submits an identification request to said biometric identification terminal 101. According to a first example, the request may be submitted by means of a human-machine interface or HMI (not shown) with which the biometric identification terminal 101 is equipped. According to a second example, it may be submitted by way of the encoding terminal 103 via a remote connection, which is preferably secure.

Once the request has been submitted, the biometric identification terminal 101 acquires a proof biometric feature of the user 103 using an appropriate acquisition device and then transmits it to the encoding terminal 102. The biometric feature is generally selected from the dermatoglyphs of one or more fingers, palmar dermatoglyphs, one or more irises, or a face, or a combination thereof.

Upon receipt of the proof biometric feature, the encoding terminal 102 generates therefrom a proof biometric template according to an encoding scheme, then sends this proof biometric template to the biometric identification terminal 101. As soon as the biometric identification terminal 101 receives the proof biometric template, it compares it with one or more reference biometric templates stored in a database. If there is a match between the proof biometric template and at least one reference biometric template, the user 103 is identified. The user is then permitted to access the resource or area. Otherwise, the user 103 is not identified and access is denied. The biometric identification terminal 101 and/or the encoding terminal may notify the user of the success or failure of the identification by means of a light signal, a sound signal, a message, or a combination thereof.

A biometric identification system 100 such as described above may be used for the purpose of accessing one or more remote services, permitting access to information stored in a communal or personal database, verifying the identity of one or more persons, retrieving login credentials, or even retrieving one or more addresses of wallets for digital currency such as cryptocurrency.

One example 200 of a biometric identification terminal 101 is illustrated in FIG. 2. The biometric identification terminal 200 comprises a physical acquisition module 201, a physical data-processing module 202 and a protective casing 203.

The physical acquisition module 201 takes the form of a camera suitable for acquiring the image of one or more irises or of a face. The protective casing 203a comprises a transparent or semi-transparent window 203a in order to allow acquisition of the image by the acquisition module 201. Alternatively or additionally, the physical acquisition module 201 may comprise a device for acquiring a dermatoglyph of one or more fingers or a palmar dermatoglyph. On the surface of the protective casing 203 there may be an acquisition zone leaving the active area of said acquisition device exposed so that a user 103 may place one or more of her or his fingers and/or the palm of one of her or his hands thereon.

The physical acquisition module 201 transmits the acquired data to the physical data-processing module 202 by means of a connector 204. The physical data-processing module 202 comprises means for implementing a biometric identification. It is responsible for automatically executing sequences of arithmetic or logic operations in order to carry out tasks or actions. This module, commonly referred to as a computer, may comprise one or more central processing units (CPUs) 202a and/or one or more graphics processing units (GPUs) 202b, a physical remote-communication module 202c, one or more physical input/output modules 202d for exchanging data with external devices, a transient storage medium 202e such as a random-access memory (RAM), a non-transient storage medium 202f, and communication busses (not shown) for transferring data between the internal components of the data-processing module 202.

The physical data-processing module 202 makes it possible to execute one or more program modules comprising instructions that, when the one or more program modules are executed, cause the data-processing module 202 to implement a biometric identification. The one or more program modules may be written in any, compiled or interpreted, programming language. They may form part of a software solution, i.e. of a collection of executable instructions, of codes, of scripts or the like and/or of databases.

Examples of such a biometric identification terminal 101 are described in the prior art, in particular in WO 2023/028221 A1 [TOOLS FOR HUMANITY CORP [US]02.03.2023; WO 2023/028242 A1 [TOOLS FOR HUMANITY CORP [US]01.03.2023; US 2008/253622 A1 [RETICA SYSTEM INC [US]]16.10.2008; US 2006/088193 A1 [RETICA SYSTEM INC [US]]24.07.2006; FR 3069681 A1 [SAFRAN IDENTITY & SECURITY [FR]]01.02.2019.

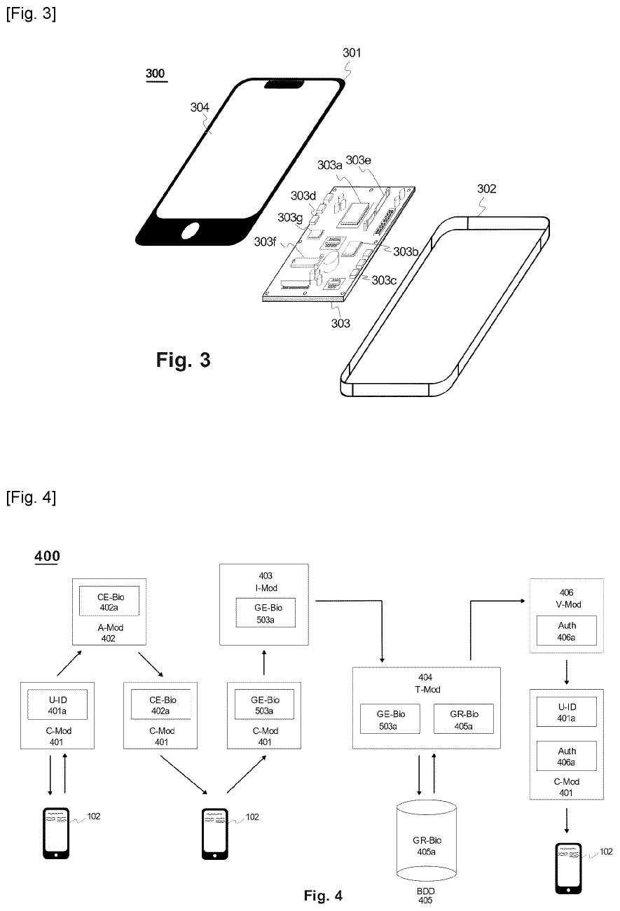

FIG. 3 shows one example 300 of an encoding terminal 102 for implementing a biometric identification. The encoding terminal 102, 300 is a mobile electronic device, preferably a smartphone. The encoding terminal 102, 300 comprises an upper protective casing 301, a lower protective casing, a physical data-processing module 202 and a human-machine interface (HMI) 304 taking the form of a touch screen.

The physical data-processing module 303 comprises means for implementing a biometric identification. It is responsible for automatically executing sequences of arithmetic or logic operations in order to carry out tasks or actions. This physical module 303, commonly referred to as a computer, may comprise one or more central processing units (CPUs) 303a and/or one or more graphics processing units (GPUs) 303b, a physical remote-communication module 303c, one or more physical input/output modules 303d for exchanging data with external devices, a transient storage medium 303e such as a random-access memory (RAM), a non-transient storage medium 303f, and communication busses (not shown) for transferring data between the internal components of the data-processing module 303. It may also comprise a secure element 303g for storing cryptographic keys, executing encryption algorithms, and/or storing and/or encrypting any other algorithm and/or datum the security and confidentiality of which must be ensured.

The physical data-processing module 303 makes it possible to execute one or more program modules comprising instructions that, when the one or more program modules are executed, cause the data-processing module 303 to implement a biometric identification. The one or more program modules may be written in any, compiled or interpreted, programming language. They may form part of a software solution, i.e. of a collection of executable instructions, of codes, of scripts or the like and/or of databases.

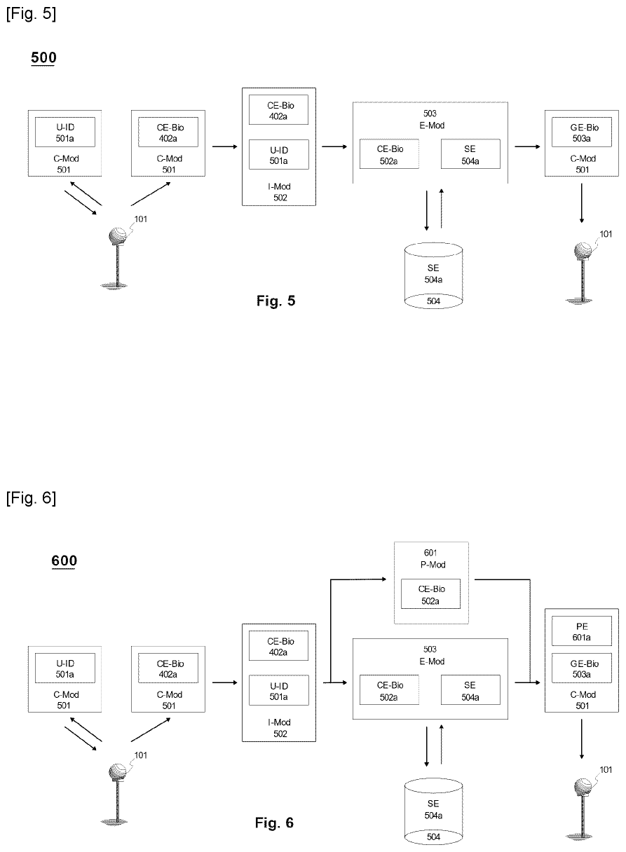

FIG. 4 and FIG. 5 respectively show charts 400, 500 of operation of a biometric identification terminal 101, 200 and of an encoding terminal 102, 300 for implementing a biometric identification.

With reference to FIG. 4, the biometric identification terminal 101, 200 may comprise a communication program module 401 (C-Mod), an acquisition program module 402 (CE-Bio) for acquiring a proof biometric feature, a data-input program module 403 (I-Mod), a data-processing program module 404 (T-Mod), a database 405 (BDD), and a validation program module 406 (V-Mod).

The data-input program module 403 (I-Mod), the data-processing program module 404 (T-Mod) and the validation program module 406 (V-Mod) may be implemented by the physical data-processing module 202 of the biometric identification terminal 101, 200 described with reference to FIG. 2. The communication program module 401 (C-Mod) and the acquisition program module 402 (CE-Bio) for acquiring a proof biometric feature may be implemented by the physical communication module 202c and the physical acquisition module 201 of said terminal 102, 200. The database 405 (BDD) may be stored on the non-transient storage medium 202f of the data-processing module 202. Alternatively, it may be stored in a non-transient electronic storage medium of a remote server with which the biometric identification terminal 101, 200 has set up a secure remote communication via, for example, the communication program module 401 (C-Mod).

With reference to FIG. 5, the encoding terminal 102, 300 may comprise a communication program module 501 (C-Mod), a data-input program module 502 (I-Mod), an encoding module 503 (E-Mod) and a non-transient storage region 504.

The data-input program module 502 (I-Mod) and the encoding program module 502 (E-Mod) may be implemented by the physical data-processing module 303 of the encoding terminal 102, 300 described with reference to FIG. 3. The communication program module 501 (C-Mod) may be implemented by the physical communication module 303c. The non-transient storage region 504 may be located in the non-transient storage medium 202f of the data-processing module 202 and/or in the secure element 303g.

The implementation of the biometric identification method briefly described with reference to FIG. 1 will now be described in detail with reference to FIGS. 2 to 5.

The communication program module 301 of the biometric identification terminal 101, 200 is configured to exchange data with remote electronic devices, such as the encoding terminal 102, 300, via a secure remote connection. The secure connection is set up by the communication program modules 401, 501 of each of the terminals 101, 200, 102, 300. When a biometric identification request is submitted to the biometric identification terminal 101, 200, the encoding terminal 102, 300 and the identification terminal 101, 200 may transmit identifiers 401a, 501a (U-ID) to each other, the function of which is to unambiguously identify each of the terminals 101, 200, 102, 300 for all subsequent exchanges, and thus verify the origin of the exchanged data. The identifiers 401a, 501a comprise any suitable type of data. Examples of possible identifiers are a MAC address, a user identifier 103, an EMEI number, a random number generated by each of the terminals 101, 200, 102, 300, or a combination thereof. Preferably, the data exchanged between the encoding terminal 102, 300 and the biometric identification terminal 101, 200 are encrypted using, for example, an asymmetric encryption protocol.

Once the communication has been set up between the biometric identification terminal 101, 200 and the encoding terminal 102, 300, the biometric acquisition program module 402 of the biometric identification terminal 101, 200 acquires a proof biometric feature 402a (CE-Bio) and then transmits it to the encoding terminal 102, 300 via its communication program module 401 (C-Mod). The encoding terminal 102, 300 receives the proof biometric feature 402a (CE-Bio) via its communication program module 501 (C-Mod). The proof biometric feature 402a (CE-Bio) is transmitted to the data-input program module 502, then to the encoding program module 503 (E-Mod). The encoding program module 503 (E-Mod) generates a proof biometric template 503a (GE-Bio) by encoding the proof biometric feature 402a (CE-Bio) according to an encoding scheme 504a (SE) stored in the non-transient storage region 504. The proof biometric template 503a (GE-Bio) is then transmitted to the communication program module 501 (C-Mod) with a view to having it sent to the biometric identification terminal 101, 200.

The communication program module 401 (C-Mod) of the biometric identification terminal 101, 200 receives the proof biometric template 503a and transmits it to the processing program module 404 via the data-input program module 403 (I-Mod). The processing program module 404 (T-Mod) compares the proof biometric template 503a with one or more reference biometric templates 405a (GR-Bio) stored in a database 405. A user 103 is associated with each reference biometric template 405a (GR-Bio). The database 405 may be stored in the non-transient electronic storage medium 202f belonging to the biometric identification terminal 101, 200. Alternatively, it may be stored in a non-transient electronic storage medium of a remote server with which the biometric identification terminal 101, 200 has set up a secure remote communication.

The proof biometric template 503a (GR-Bio) is compared with one or more reference biometric templates 405a (GR-Bio) using any suitable method. For example, when the biometric templates take the form of encoding vectors, the comparison may be computation of a match score taking the form of a scalar product, of a vector product or of an Euclidean distance between the vector representative of the proof biometric template 503a (GE-Bio) and each of the vectors representative of the reference biometric templates 405a (GR-Bio).

According to certain embodiments, the proof biometric template 503a (GE-Bio) is compared with one or more reference biometric templates 405a (GR-Bio) using a fuzzy search protocol, preferably a fuzzy search protocol based on a Hamming distance. A fuzzy search has the advantage of being fast when it is a question of comparing complex data, such as biometric templates, and/or when the number of biometric templates to be compared is high. One example of implementation of a fuzzy search based on a Hamming distance is described in the article Galbraith & Zoberning (2019), “Obfuscated fuzzy hamming distance and conjunctions from subset product problems.”, Theory of Cryptography Conference.

According to certain preferred embodiments, the proof biometric template 503a (GE-Bio) is compared with one or more reference biometric templates 405a (GR-Bio) using a data-obfuscation and/or function-obfuscation method. Data obfuscation and/or function obfuscation makes it possible to make the programs and algorithms unintelligible while preserving their functionality or operability. In other words, in the context of the invention, the way in which the proof biometric template 503a (GE-Bio) is compared with one or more reference biometric templates 405a (GR-Bio) remains concealed from any third party observer without adversely affecting the result and performance of the comparison. Examples of implementation of a data-obfuscation and/or function-obfuscation method are described in the articles Galbraith & Zoberning (2019), “Obfuscated fuzzy hamming distance and conjunctions from subset product problems.”, Theory of Cryptography Conference, and Barak et al. (2014) “Obfuscation for evasive functions.” Theory of Cryptography Conference. Berlin, Heidelberg: Springer Berlin Heidelberg.

The validation program module 406 (V-Mod) determines whether the one or more results of the comparisons performed by the processing program module 405 (T-mod) meet at least one validation criterion, in which case the user 103 is identified. For example, when these results are match scores, the validation criterion may be a threshold value with which the score values are compared. If the value of at least one score is less than the threshold value, the user 103 is considered to have been identified. In contrast, if the score values are all greater than the threshold value, the user has not been identified and any access is denied to her or him by the biometric identification terminal 101, 200.

The validation program module 406 (V-Mod) may generate an authentication variable 406a (Auth), for example a Boolean variable, depending on whether the identification is successful (Auth=TRUE) or not (Auth=False). The value of the authentication variable 406a may be transmitted to the communication program module 401 to inform the user 103 of the success or failure of the identification via the communication program module 501 (C-Mod) of the encoding terminal 102, 300.

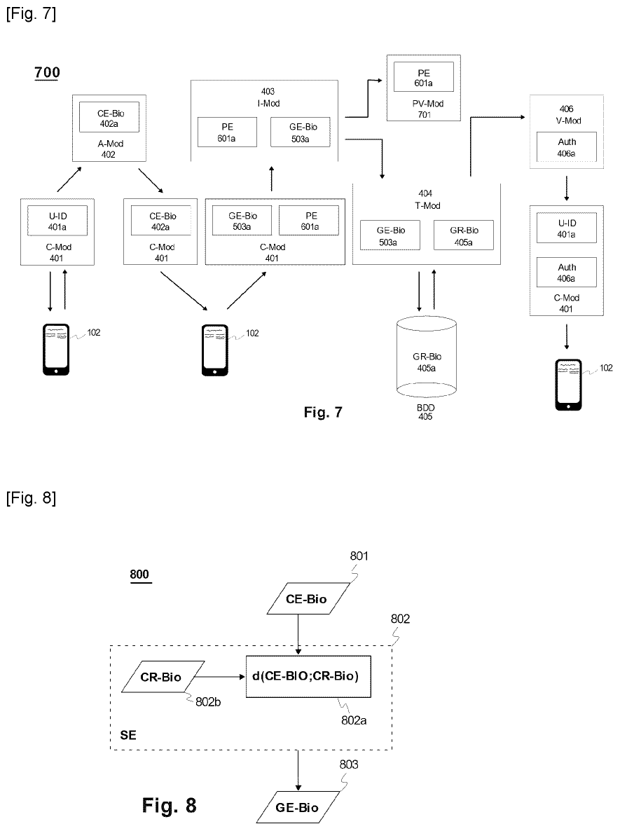

With reference to FIG. 6, the encoding terminal 102, 300 may comprise a generation program module 601 (P-Mod) for generating a proof 601a (PE) of encoding of the proof biometric template 503a (GE-Bio) from the proof biometric feature 402a (CE-Bio) transmitted by the biometric identification terminal 101, 200. After generation, this encoding proof 601a (PE) is transmitted to the biometric identification terminal 101, 200 at the same time as the proof biometric template 503a (GE-Bio). With reference to FIG. 7, the biometric identification terminal 101, 200 may comprise a verification program module 701 (PC-Mod) for verifying the received encoding proof (PE).

The function of the encoding proof is to allow the biometric identification terminal 101, 200 to verify that the proof biometric template was actually generated by the encoding terminal 102, 300 from the proof biometric feature transmitted to it, and not from another datum. Preferably, the encoding proof is a zero-knowledge proof.

By way of example, when the encoding scheme 802, 902, 1002, 1102 (SE) is in particular implemented in the form of a neural network in accordance with the embodiments described below, a zero-knowledge proof may be generated according to the method described in South et al. (2024) “Verifiable evaluations of machine learning models using zkSNARKs.” arXiv preprint arXiv:2402.02675.

According to the invention, with reference to FIG. 8, the encoding terminal 101, 300 comprises means for implementing a method 800 for encoding a proof biometric template 803, said method having, as input datum, a proof biometric feature 801 (CE-Bio), and delivering, as output datum, a proof biometric template 803 (GE-Bio), wherein the proof biometric template 803 (GE-Bio) is generated from the proof biometric feature 801 (CE-Bio) according to an encoding scheme 802 (SE) representative of the distance 802a (d(CE-Bio, CR-Bio)), according to a metric, between the proof biometric feature 801 (CE-Bio) and a reference biometric feature 802b (CR-Bio).

By virtue of the encoding method 800 according to the invention, the distance between the proof biometric template 803 (GE-Bio) generated by the encoding terminal 101, 300 and any given reference biometric template (GR-Bio) to which it is liable to be compared subsequently, increases as the distance of the proof biometric feature 801 (CE-Bio) from which it was generated to the reference biometric feature 802b (CR-Bio) increases. Thus, the risk of false acceptance is considerably decreased because the greater the distance between the proof biometric feature 801 (CE-Bio) and the reference biometric feature 802b (CR-Bio), the more the proof biometric template 803 (GE-Bio) is altered compared to a situation in which the proof biometric feature 801 (CE-Bio) is identical or close to the reference biometric feature 802b (CR-Bio).

By way of illustrative example, in the context of the biometric identification method illustrated in FIGS. 1 to 5, a user 103 presents her or himself in front of a biometric identification terminal 101, 200 with a view to accessing a resource. In the event that the user 103 is an identity thief, she or he is equipped with an encoding terminal 102, 300 that she or he has purloined from a third party, and is attempting to impersonate that person. The reference biometric feature 802b (CR-Bio) used in the identification method 800 implemented by the purloined encoding terminal 102, 200 is that of the third party.

The biometric identification terminal 101, 200 acquires a proof biometric feature 402a (CE-Bio) of the identity thief 103 and transmits it to the encoding terminal 102, 300. The encoding terminal 102 receives the proof biometric feature 402a, 801 (CE-Bio) and generates a proof biometric template 503a, 803 (GE-Bio) therefrom according to its encoding scheme 802 (SE), i.e. one representative of a distance 802a (d(CE-Bio, CR-Bio)), according to a metric, between the proof biometric feature 402a, 801 (CE-Bio) of the identity thief 103 and the reference biometric feature 802b (CR-Bio) of the third party to whom the encoding terminal 102, 300 belongs. Since the proof biometric feature 402a, 801 (CE-Bio) of the identity thief 103 is different from that of the third party who owns the terminal, the encoding terminal 102, 300 generates a proof biometric template 503a, 803 (GE-Bio) that is completely different from the one that it would have generated if the user 103 were the third party.

Once the proof biometric template 503a, 803 (GE-Bio) has been generated, the encoding terminal 102, 300 transmits it to the biometric identification terminal 101, 200. The latter compares it to the reference biometric templates 405a (GR-Bio) of a database 405, and fails to obtain a match with a reference biometric template 405a (GR-Bio) of the third party recorded in the database 405.

In other words, the encoding method 800 according to the invention makes it possible to camouflage any “authentic” proof biometric template (GE-Bio) liable to be generated from a proof biometric feature (CR-Bio) similar to the reference biometric feature (CR-Bio), provided that the proof biometric feature (CE-Bio) does not match said reference biometric feature (CR-Bio). In particular, this camouflage is obtained by generating a proof biometric template (GE-Bio) the randomness of which increases as the difference between the proof biometric feature (CE-Bio) and the reference biometric feature (CR-Bio) increases.

The encoding method 800 according to the invention is implemented by one or more program modules, and in particular by the encoding program module 503 of the encoding terminal 102, 300. The one or more program modules are executed by the data-processing module 303 of the encoding terminal 102, 300. All or some of these modules may be executed by a secure element 303g of the physical data-processing module 303.

It will be noted here that the encoding scheme 802 (SE) is based on a distance 802a (d(CE-Bio, CR-Bio)), according to a metric, between the proof biometric feature 801 (CE-Bio) and a reference biometric feature 802b (CR-Bio). In other words, the distance according to a metric is a distance between the raw data of the proof biometric feature 801 (CE-Bio) and the reference biometric feature 802b (CR-Bio). Optionally, the raw data may undergo digital pre-processing (such as noise reduction, edge detection or even cropping) without modifying their constituent information as in the case of biometric template generation.

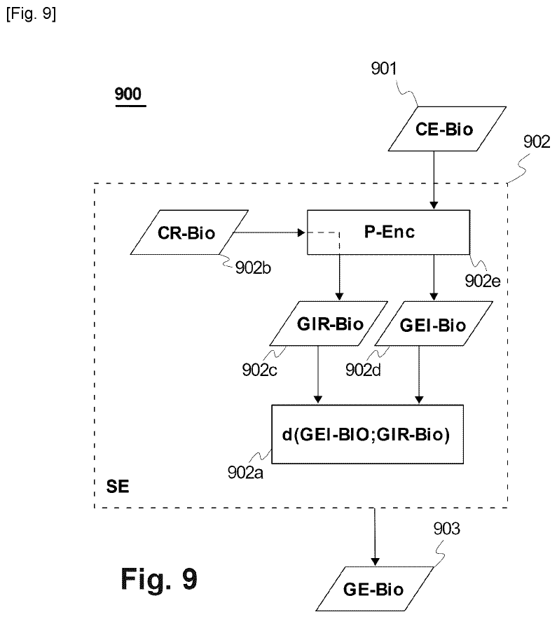

Equivalently, with reference to FIG. 9, the encoding scheme 902 (SE) may be based on a distance 902a (d(GEI-Bio, GIR-Bio)) between an internal reference biometric template 902c (GIR-Bio) generated from the reference biometric feature 902b (CR-Bio) and an intermediate proof biometric template 902d (GEI-Bio) generated from the proof biometric feature 901 (CE-Bio). In these embodiments, the encoding scheme 902 (SE) may comprise a pre-encoder 902e (P-Enc) configured to generate an internal reference biometric template 902c (GIR-Bio) generated from the reference biometric feature 902b (CR-Bio) and an intermediate proof biometric template 902d (GEI-Bio) generated from the proof biometric feature 901 (CE-Bio). The encoding terminal 102, 300 then generates a proof biometric template 903 (GE-Bio) on the basis of this distance 902a in accordance with the encoding scheme 902 (SE).

The pre-encoder 902e (P-Enc) may be a generic prior-art encoder. For example, in the case of a biometric feature consisting of one or more images of a user 103, it may be a pre-encoder as described in Hasnat et al. (2017) “Deepvisage: Making face recognition simple yet with powerful generalization skills.” Proceedings of the IEEE International Conference on Computer Vision Workshops. The internal reference biometric template 902c (GIR-Bio) generated from the reference biometric feature 902b (CR-Bio) and the intermediate proof biometric template 902d (GEI-Bio) generated from the proof biometric feature 901 (CE-Bio) generally take the form of vectors.

The metric quantifying the distance between the proof biometric feature 901 (CE-Bio) and the reference biometric feature 902b (CR-Bio) and/or between an internal reference biometric template 902c (GIR-Bio) generated from the reference biometric feature 902b (CR-Bio) and an intermediate proof biometric template 902d (GEI-Bio) generated from the proof biometric feature 901 (CE-Bio) is of any suitable type. In particular, it may be a scalar product, a vector product, a Euclidean distance or even a Hamming distance.

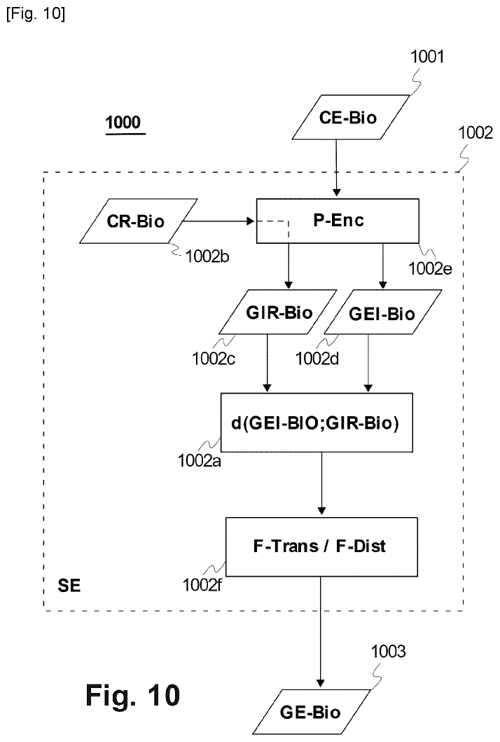

According to certain embodiments, with reference to FIG. 10, the encoding scheme 10002 (SE) comprises a transition function 1002f (F-Trans) or a distribution function (F-Dist) centered on the distance 1002a (d(GEI-Bio, GIR-Bio)), according to a metric, between an internal reference biometric template 1002c (GIR-Bio) generated from the reference biometric feature 1002b (CR-Bio) and an intermediate proof biometric template 1002b (GEI-Bio) generated from the proof biometric feature 1001 (CE-Bio).

By way of example of embodiment, a transition function 1002f (F-trans) of the encoding scheme 1002 may be expressed using the following formula:

GE=f_{Trans}(GEI)=h(GEI·GIR)×GIR
where GE is the proof biometric template (GE-Bio), GEI is an intermediate proof biometric template 1002b (GEI-Bio) generated from the proof biometric feature 1001 (CE-Bio), GIR is an internal reference biometric template 1002c (GIR-Bio) generated from the reference biometric feature 1001 (CR-Bio), GEI. GIR is the scalar product of GEI and GIR and represents the distance 1002a (d(GEI-Bio, GIR-Bio)) between the intermediate proof biometric template 1002b (GEI-Bio) and the internal reference biometric template 1002c (GIR-Bio); and the function h is a decreasing function such that:

$$h : [ 0.1 ] \to [ 0.1 ] , x \to \{ \begin{matrix}1 if x = 1 \\ {lim}_{x \to 0} h ( x ) = 0\end{matrix}$$

When the intermediate proof biometric template 1002d (GEI-Bio) generated from the proof biometric feature 1001 (CE-Bio) is close to the internal reference biometric template 1002c (GIR-Bio) generated from the reference biometric feature 1002b (CR-Bio), or in other words when the proof biometric feature 1001 (CE-Bio) and the reference biometric feature 1002b (CR-Bio) belong to the same user 103, their scalar product tends toward unity. The encoding scheme 1002 (SE) generates, via the transition function 1002f (F-trans), a proof biometric template 1003 (GE-Bio) that is similar, or even identical, to the reference biometric template 405a (GR-Bio) expected by the biometric identification terminal 101, 200. In contrast, if the intermediate proof biometric template 1002d (GEI-Bio) and internal reference biometric template 1002c (GIR-Bio) do not match, the scalar product tends toward zero. The encoding scheme 1002 (SE) generates, via the transition function 1002f (F-trans), a proof biometric template 1003 (GE-Bio) that is very different from the reference biometric template 405a (GR-Bio) expected by the biometric identification terminal 101, 200.

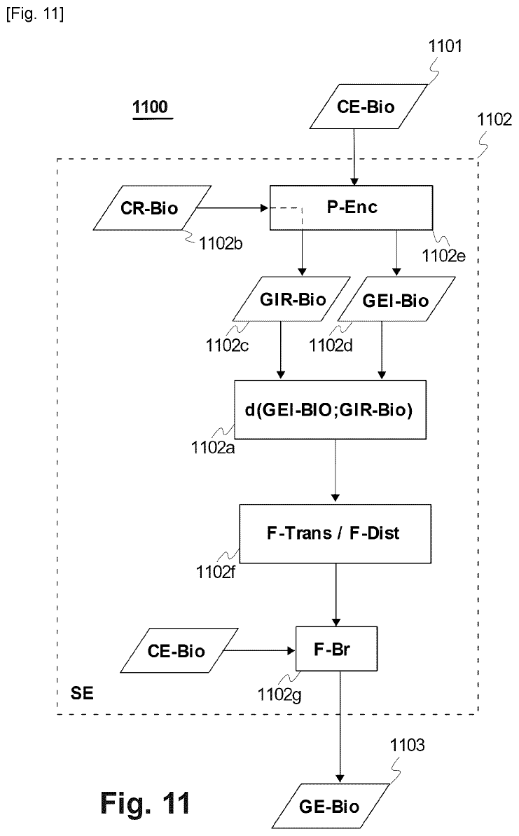

In order to increase the level of security, and therefore decrease the risk of false acceptance, it may be advantageous to increase the degree of dissimilarity of the reference biometric feature in the event of identity theft. According to certain advantageous embodiments, with reference to FIG. 11, the encoding scheme 11002 (SE) further comprises a noise-generation function 11002g (F—Br), preferably a noise-generation function that has, as input variable, the proof biometric feature 11001 (CE-Bio).

By way of example of embodiment, one noise-generation function 1102g (F—Br) having, as input variable, the proof biometric feature 11001 (CE-Bio) may be expressed using the following formula:

$${f}_{Br} ( GEI ) = ( 1 - {f}_{Trans} ( GEI ) ) \times g ( CE )$$

where CE is the proof biometric feature 11001 (CE-Bio), GEI is an intermediate proof biometric template 1102d (GEI-Bio) generated from the proof biometric feature 1101 (CE-Bio), F-trans is a transition function and g is a function that generates a random number from the proof biometric feature 1101 (CE-Bio). The function g may be a hash function, a weighted summation function or a reduction function.

Starting with the above example of a transition function (F-trans), the proof biometric template 11003 (GE-Bio) generated by the encoding terminal 102, 200, according to the encoding scheme 11002 (SE), may be expressed according to the following relationship:

$$GE = {f}_{Trans} ( GEI ) + {f}_{Br} ( GEI ) = ( GEI . GIR ) \times GIR + ( 1 - ( ( GEI . GIR ) \times GIR ) ) \times g ( CE ) .$$

In the embodiments described above, the encoding scheme 802, 902, 1002, 1102 (SE) and/or the reference biometric feature 802b, 902b, 1002b, 1102b (CR-Bio) are stored, preferably in encrypted form, in the non-transient storage medium 302f of the physical data-processing module 303 of the encoding terminal 102, 300. They may also be stored in a secure element 303a of the physical data-processing module 303 of the encoding terminal 102, 300. The one or more encoding program modules 503 (E-mod) may be executed within this secure element 303a.

It is also possible to increase the level of security by making it impossible for an identity thief or fraudster to reconstruct the encoding scheme 802, 902, 1002, 1102 (SE) and/or the reference biometric feature 802b, 902b, 1002b, 1102b (CR-Bio) by analyzing the results of brute force tests and of a heuristic approach such as a trial-and-error method. To this end, according to advantageous embodiments, the encoding scheme 802, 902, 1002, 1102 (SE) is implemented in the form of a neural network trained beforehand using a teacher-student protocol.

Thus, a neural network may be trained beforehand using a teacher-student protocol to reproduce the outputs of the transition, distribution and/or noise functions described in the above embodiments and the distance 802b, 902b, 1002b, 1102b between the proof and reference biometric features (CE-Bio, CR-Bio) and/or the intermediate proof and reference biometric templates (GEI-Bio, GIR-Bio). One example of a neural network trained according to a teacher-student protocol is described in the article Papernot et al. (2016) “Semi-supervised knowledge transfer for deep learning from private training data.” arXiv preprint arXiv:1610.05755. Such an approach also has the advantage of being able to use a neural network the structure of which is less complex than that of a conventional neural network, i.e. a neural network designed ab initio to implement the encoding scheme without training using a teacher-student protocol. The execution of the encoding scheme 802, 902, 1002, 1102 (SE) is then faster and more accurate.

According to certain examples, the training method of such a neural network may further be based on a loss function the parameters of which are adjusted so that the neural network delivers a proof biometric template (GE-Bio) that reproduces the reference biometric feature (CR-Bio) with increasing fidelity the closer it gets to the proof biometric feature (CE-Bio). In particular, it may be advantageous to use a fine-tuning approach whereby a neural network trained beforehand to deliver a proof biometric template (GE-Bio) from a proof biometric feature (CE-Bio) becomes specialized in the reference biometric feature (CR-Bio).

According to certain examples, the neural network may further be trained using a plurality of reference biometric features (CR-Bio) of same nature in order to increase the sensitivity of the neural network. A plurality of acquisitions of the same reference biometric feature (CR-Bio) of the user 103 may then be carried out, on the basis of which acquisitions the neural network is trained via the encoding scheme (SE) that it must reproduce.

According to preferred embodiments, the encoding scheme 802, 902, 1002, 1102 (SE) is specific to the biometric encoding terminal 102, 300. The encoding scheme 802, 902, 1002, 1102 (SE) then differs from one encoding terminal 102, 300 to another, introducing an additional degree of diversity during generation of the proof biometric template (GE-Bio) when the proof biometric feature (CE-Bio) deviates from the reference biometric feature 802b (CR-Bio). In other words, more figuratively, the more the proof biometric feature (CE-Bio) differs from the reference biometric feature (CR-Bio) the more each encoding terminal 102, 300, via the encoding scheme specific to it, “camouflages” or “conceals” in its own way the reference biometric feature.

According to certain embodiments, the reference biometric feature (CR-Bio) is specific to the user 103 of the encoding terminal 102, 300. In particular, when the user 103 is the owner of the encoding terminal 102, 300, the reference biometric feature (CR-Bio) is exclusively that of said user 103. By way of example, the encoding terminal 102, 300 is a mobile electronic device, such as a smartphone of which the user 103 is the sole owner. The reference biometric feature (CR-Bio) is then a reference biometric feature (CR-Bio) of the user 103.

### REFERENCES

### Patent Literature

U.S. Pat. No. 4,109,237 A [HILL ROBERT B]22.08.1978.
WO 9526013 A1 [MINNESOTA MINING & MFG [US]]28.09.1995.
US 2006/088193 A1 [RETICA SYSTEM INC [US]]24.07.2006.
US 2008/253622 A1 [RETICA SYSTEM INC [US]]16.10.2008.
EP 2 813 961 A1 [KONVALINKA IRA [CA]]17.12.2014.
WO 2017/019972 A1 [VISA INT SERVICE ASS [US]]02.02.2017.
WO 2017/075063 A1 [VISA INT SERVICE ASS [US]]04.07.2017.
FR 3069681 A1 [SAFRAN IDENTITY & SECURITY [FR]]01.02.2019.
WO 2019/078858 A1 [VISA INT SERVICE ASS [US]]25.04.2019.
WO 2019/094071 A1 [VISA INT SERVICE ASS [US]]16.05.2019.
WO 2023/028242 A1 [TOOLS FOR HUMANITY CORP [US]01.03.2023.
WO 2023/028221 A1 [TOOLS FOR HUMANITY CORP [US]02.03.2023.

### Non-Patent Literature

ISO/IEC 19794-1:2011 Information technology—Biometric data interchange formats—Part 1: Framework.
Barak et al. (2014) “Obfuscation for evasive functions.” Theory of Cryptography Conference. Berlin, Heidelberg: Springer Berlin Heidelberg.
Papernot et al. (2016) “Semi-supervised knowledge transfer for deep learning from private training data.” arXiv preprint arXiv:1610.05755.
Hasnat et al. (2017) “Deepvisage: Making face recognition simple yet with powerful generalization skills.” Proceedings of the IEEE International Conference on Computer Vision Workshops.
Galbraith & Zoberning (2019), “Obfuscated fuzzy hamming distance and conjunctions from subset product problems.”, Theory of Cryptography Conference.
South et al. (2024) “Verifiable evaluations of machine learning models using zkSNARKs.” arXiv preprint—arXiv:2402.02675.

1. A method for encoding, implemented by an encoding terminal, a proof biometric template, said method having, as input datum, a proof biometric feature, and delivering, as output datum, a proof biometric template,
wherein the proof biometric template is generated from the proof biometric feature according to an encoding scheme representative of the distance according to a metric, between the proof biometric feature and a reference biometric feature.

2. The encoding method as claimed in claim 1, wherein the encoding scheme comprises a pre-encoder configured to generate an internal reference biometric template generated from the reference biometric feature and an intermediate proof biometric template generated from the proof biometric feature, the distance according to a metric being a distance between the internal reference biometric template and the intermediate proof biometric template.

3. The encoding method as claimed in claim 1, wherein the encoding scheme comprises a transition function or a distribution function centered on the distance, according to a metric, between an internal reference biometric template generated from the reference biometric feature and an intermediate proof biometric template generated from the proof biometric feature.

4. The encoding method as claimed in claim 1, wherein the encoding scheme further comprises a noise-generation function, preferably a noise-generation function that has, as input variable, the proof biometric feature.

5. The encoding method as claimed in claim 4, wherein the noise-generation function comprises a function that generates a random number from the proof biometric feature, selected from a hash function, a weighted summation function and a reduction function.

6. The encoding method as claimed in claim 1, wherein the encoding scheme is implemented in the form of a neural network trained beforehand using a teacher-student protocol.

7. The encoding method as claimed in claim 1, such that the encoding scheme is specific to the biometric terminal.

8. The encoding method as claimed in claim 1, wherein the reference biometric feature is specific to the user of the encoding terminal.

9. An encoding terminal comprising means for implementing the encoding method as claimed in claim 1.

10. The encoding terminal as claimed in claim 9, wherein the encoding terminal is a mobile electronic device.

11. A biometric identification method, comprising:
a) transmission, by a biometric identification terminal, of a proof biometric feature of an individual to an encoding terminal;
b) generation, by the encoding terminal, of a proof biometric template using an encoding method as claimed in claim 1;
c) reception, by the biometric identification terminal, of the proof biometric template; and
d) comparison, by the biometric identification terminal, of the proof biometric template with at least one reference biometric template of a database of reference biometric templates.

12. The identification method as claimed in claim 11, wherein the comparison step d) is executed using a fuzzy search protocol.

13. The identification method as claimed in claim 11, further comprising a step of generation, by the encoding terminal, of a proof of encoding of the proof biometric template from the proof biometric feature, and a step of verification, by the biometric identification terminal, of the encoding proof.

14. The method as claimed in claim 11, wherein the comparison step is executed using a data-obfuscation and/or function-obfuscation method.

15. A biometric identification system, comprising:
a biometric identification terminal comprising an acquisition device configured to acquire at least one proof biometric feature of a user;
a storage medium comprising a database of reference biometric templates;
the encoding terminal;
the system being configured to execute the steps of an identification method as claimed in claim 11.
